(19) United States
(12) Patent Application Publication
(10) Pub. No.: US 2005/0074033 A1
(43) Pub. Date: Apr. 7, 2005

(54) Method and apparatus for measuring network timing and latency

(76) Inventor: Claude J. Chauveau, Portland, OR (US)

Correspondence Address: MARGER JOHNSON & MCCOLLOM, P.C., 1030 SW MORRISON STREET, PORTLAND, OR, 97205, US

(21) Appl. No.: 10/956,503

(22) Filed: Oct. 1, 2004

Related U.S. Application Data
(60) Provisional application No. 60/508,479, filed on Oct. 3, 2003.

(51) Int. Cl. H04J 3/06

(52) U.S. Cl. 370/503

(57) ABSTRACT

A method and system for time stamping and authenticating packets of financial data, like orders to buy or sell and confirmations of such orders and resulting trades. The packets are stamped and encrypted multiple times as they enter and leave communications networks and during market processing. Market data, including information about all of the orders and trades generated at the market, is likewise time stamped and distributed to subscribers. This resulting timing data can be used in an algorithmic trading application to make trading decisions. When multiple markets are so equipped, an accurate time-aligned database of market activity may be utilized to develop algorithmic trading applications or for forensic purposes. Packets can also be rerouted or switched to a private network for multicasting to subscribers. The packets are processed to preserve proper handling by downstream routers and switches even though timing data is added to the application layer.

### BACKGROUND OF THE INVENTION

The present invention relates generally to the relative timing and latency of data transmitted over networks and, more particularly, to a system for precisely measuring and comparing network data timing and latency.

As used herein, the term data timing refers to whether a particular data packet arrives before or after another packet, i.e., to sequencing of data on the network. As used herein, the term data latency refers to the length of time a particular data packet takes to traverse the network or a portion thereof. Various techniques for time-stamping data packets that traverse a network are known in the art. For example, see U.S. Pat. Nos. 5,600,632 and 6,252,891. In addition, network timing protocol (NTP) synchronizes the clocks of computers over a network. Time-stamping can therefore be used to measure timing and latency more accurately than when the computer clocks are not synchronized.

Some of the prior art techniques for measuring network timing and latency use a time standard that is derived from a clock at a single location. If it is desired to measure relative timing and latency of networks that are distributed around the world, delay in propagating the standard time signal affects these measurements. In some applications, timing and latency measurements, especially the relative timing and latency of multiple networks—whether linked or not—is critical. For example, it would be desirable to have very accurate timing and latency information for networks that provide financial data, such as bid, ask, and sales prices, from various markets around the world.

It would also be desirable to have such latency and timing information on various types of control systems, such as control systems that operate the power grid in the United States. Low accuracy timing and latency information plagued investigators probing the roots of the massive Aug. 14, 2003 blackout in the United States and Canada. Blackouts Precise Sequence is Illusive to Investigators, Smith, Rebecca, The Wall Street Journal, Aug. 26, 2003.

### BRIEF DESCRIPTION OF THE DRAWINGS

FIG. 1 is a schematic illustration of one approach for time-stamping and encoding a data packet on a network.

FIG. 2 is a schematic illustration of the manner in which a packet encoded as depicted in FIG. 1 is decoded.

FIG. 3 is a schematic illustration of two possible database formats for storing the data decoded in FIG. 2.

FIG. 4 is a schematic illustration of a method for digital notarization of the Record Format A data in FIG. 3.

FIG. 5 is a schematic illustration of the present system applied to financial exchanges.

FIG. 6 is a more detailed schematic illustration of the system of FIG. 5.

FIG. 7 is a schematic illustration depicting the components of message latency.

FIG. 8 is another embodiment of the present invention.

FIG. 9 is a timing diagram illustrating the relative times of data transmission and receipt in the system of FIG. 8.

FIG. 10 is another depiction that is essentially the embodiment of FIG. 8.

FIG. 11 depicts both another embodiment of the present invention and a prior art system.

FIGS. 12A and 12B illustrate the data format used in one embodiment of the invention.

FIGS. 13A and 13B comprise an expanded depiction of the FIGS. 12A and 12B format.

### DETAILED DESCRIPTION OF THE PREFERRED EMBODIMENTS

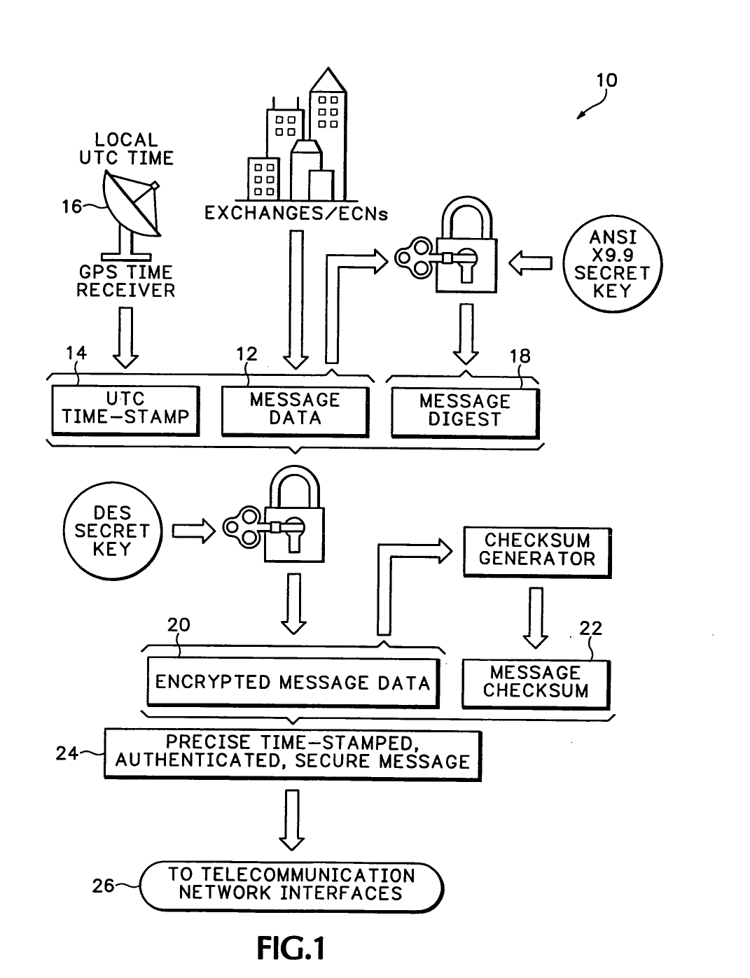

Turning now to FIG. 1, indicated generally at 10, is a method for precisely time-stamping and securely encoding data taken from a network. In the illustration of FIG. 1, message data 12 is from a financial exchange, electronic communications network (ECN) or alternate trading system (ATS), all of which are stock trading systems. Message data 12 is therefore typically data such as the price paid, bid, or asked, for a particular stock. In the illustration of system 10, the message data may be generated from one or more markets, such as NASDAQ (a well-known electronic communication network for trading stock), The New York Stock Exchange, and other ECNs or ATSs. Before the data is provided by each market to a communications network, e.g., for transmission to a brokerage, a coordinated universal time (UTC) stamp 14 (identified herein as Tx) is applied to each data packet, as shown in FIG. 1. UTC, or Zulu time as it is sometimes known, is a well-known 24-hour time format, as follows: Hours-0:23, Minutes-0:59, Seconds-0:59, Microseconds-0:999999. As shown in FIG. 1, this time is derived from a Global Positioning Satellite (GPS) receiver 16. Although it could be taken direct from a receiver of a GPS satellite signal, it could also be derived from a network, such as a CDMA cellular network, that includes GPS time information.

After time-stamping, a message digest 18 of the concatenated UTC Time-Stamp 14 and message data 12 is created using a secure hashing algorithm method, in the present embodiment ANSI X9.9 and a signing key. Digest 18 is then appended to the message data 12 and UTC Time-Stamp 14 and the result is encrypted using a symmetric encryption algorithm, in this case DES, and a secret key, thus producing encrypted message data 20. A message checksum 22 is then calculated from encrypted message data 20 and appended thereto to generate a time-stamped, authenticated, and secure message datagram 24 that is transmitted over telecommunication networks 26 to an end user. In the present embodiment of the invention, a network processor, such as Intel's IXP2850 Network Processor performs the above-described steps and places datagram 24 onto network 26. Such a network processor can encrypt and sign approximately 40 million packets per second, thus keeping the above-described process operating in substantially real time.

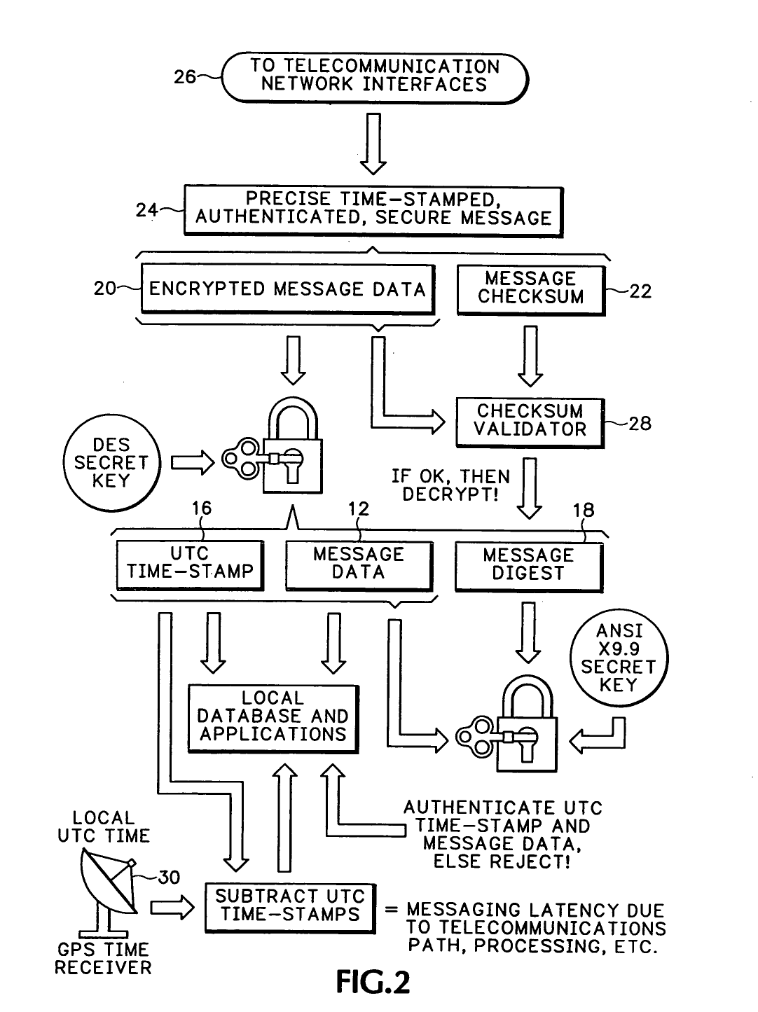

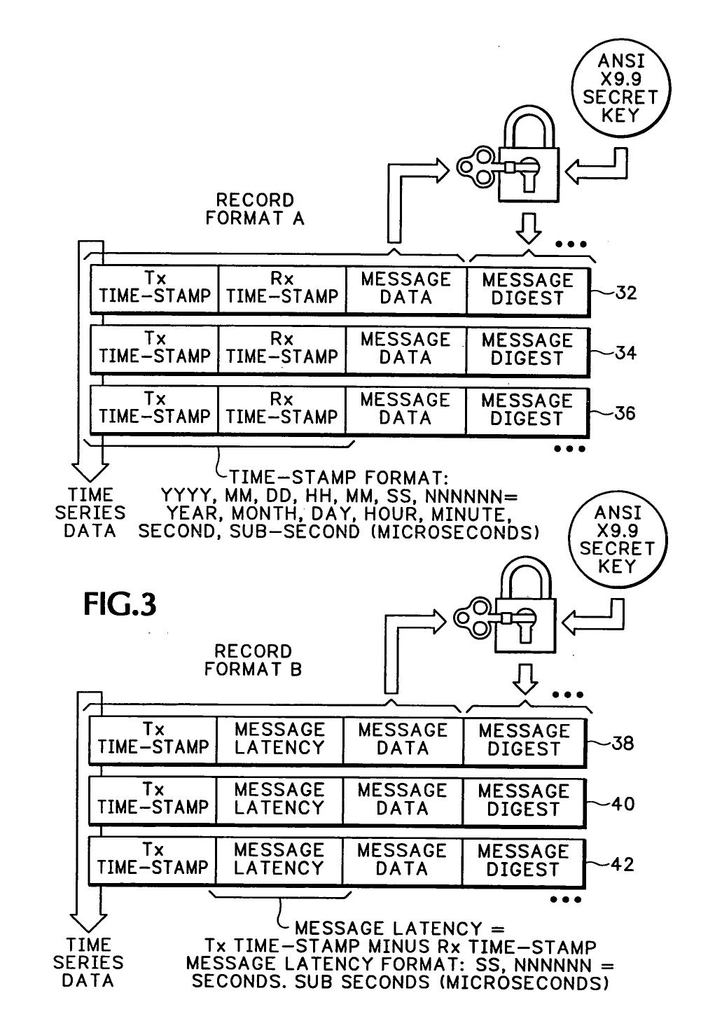

Turning now to FIG. 2, datagram 24 has been transmitted over network 26 to an end user, such as a brokerage. A checksum validator 28 verifies checksum 22 to ensure that the encrypted message data 20 is received without error. If no error is detected, the encrypted message data 20 is then decrypted as shown to expose the received UTC time-stamp 14, message data 12 and message digest 18. Message digest 18 is then compared to a message digest (not shown in the drawing) calculated from UTC time-stamp 14 and message data 12. If this recomputed digest matches message digest 18, both UTC time-stamp 14 and message data 12 are therefore authentic and valid. Finally, to compute the latency of message data 12, UTC time-stamp 14 is subtracted from a second locally generated UTC time-stamp (identified herein as Rx) obtained from a second GPS-synchronized time receiver 30. UTC time-stamp 14, message data 12, the second UTC time-stamp and derived message data latency (Rx minus Tx) are then stored in a local database, in one of the formats depicted in FIG. 3, or are used by local applications, as will be described hereinafter, or both stored and used.

The process depicted in FIG. 2 may also be advantageously performed using a network server, positioned at the receiving end of the telecommunications network 26 where the end user is located, such as the Intel network processor IXP2850.

FIG. 3 depicts two different formats for storing data that was successfully authenticated and verified as shown in FIG. 2. In record format A, both the transmitted (Tx) and the received (Rx) time-stamps are stored with the message data and a message digest derived from the transmitted and received time-stamps and the message data. Such a digest may be created using another secure hashing mechanism implemented with ANSI X9.9. Time, data and digests associated with three separate exemplary transmissions 32, 34, 36 are each shown in record format A.

Record format B, in FIG. 3, differs slightly in that the transmission time and message latency (Rx minus Tx) is stored with the message data and message digest created from the first three data fields. Time, data and digests associated with three separate exemplary transmissions 38, 40, 42 are each shown in record format B.

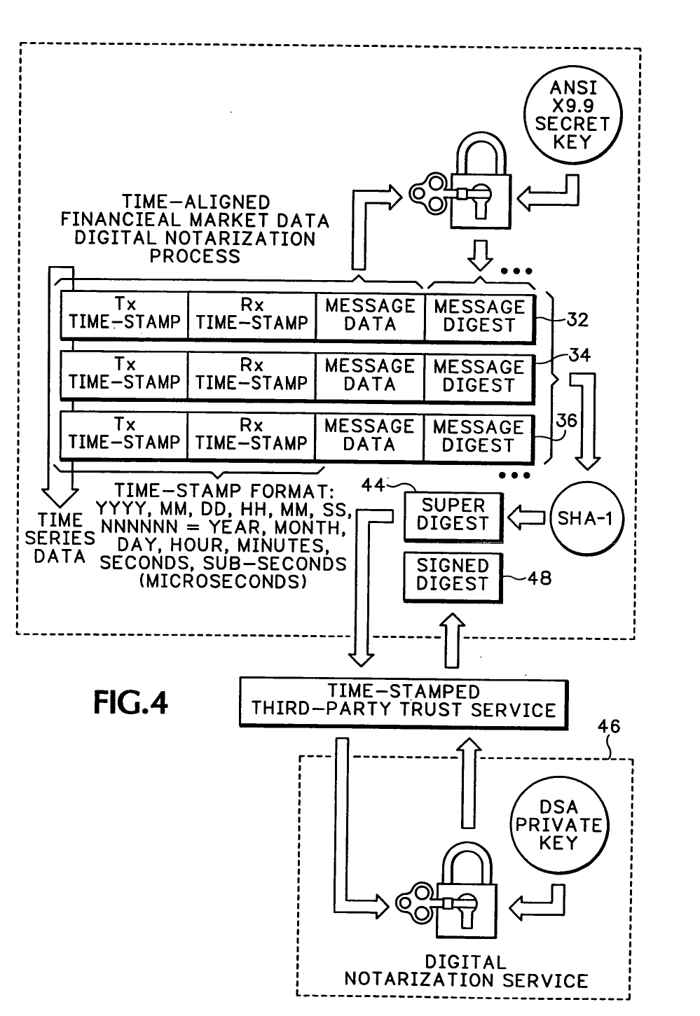

In FIG. 4, record format A from FIG. 3 is hashed using a secure hashing mechanism such as SHA-1, to create a tamper-proof digital fingerprint or super digest 44 of the underlying data. Although record format A is depicted in FIG. 4, record format B or other similar record formats could be utilized in the notarization process of FIG. 4.

The super digests, like super digest 44, generated by SHA-1 in FIG. 4 are sent to an external trust provider 46 for digital notarization, which creates a signed digest 48 that is stored in a database along with the original financial market data and time-stamps to create an irrefutable, externally verifiable, historical record of the market, or markets, such as NASDAQ, from which the information is derived.

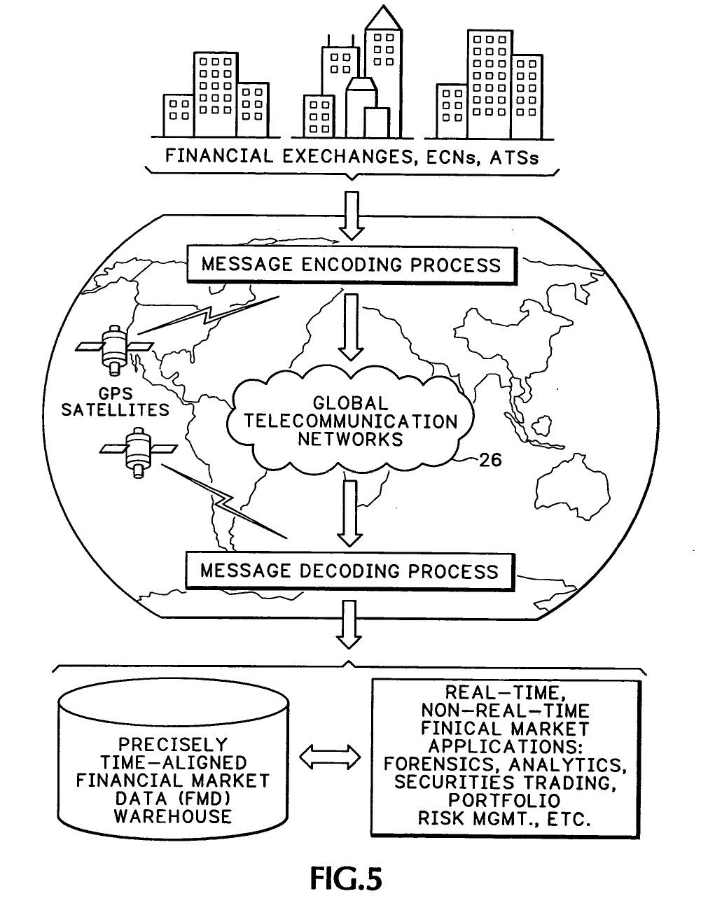

Turning now to FIG. 5, data from financial exchanges, ECNs, and ATSs, are encoded as described in FIG. 1 and applied to networks 26. An end user receives data from network 26 and decodes it as described in FIG. 2. The resulting data can be stored in a database, referred to as a warehouse in FIG. 5, using one of the record formats described in FIG. 3, and notarized as described in FIG. 4. Alternatively, or in addition to so storing the data, real time financial market applications can be used to make trading decisions or to select a particular data source. As an example of the latter, private companies such as Reuters, Bloomberg Financial, etc., provide financial data from various markets. An end user of the FIG. 5 system may compare timing and latency from various data sources and select an optimal source. Some of these sources include time-stamps applied by prior art methods. The FIG. 5 system can therefore be used to test the accuracy of those stamps.

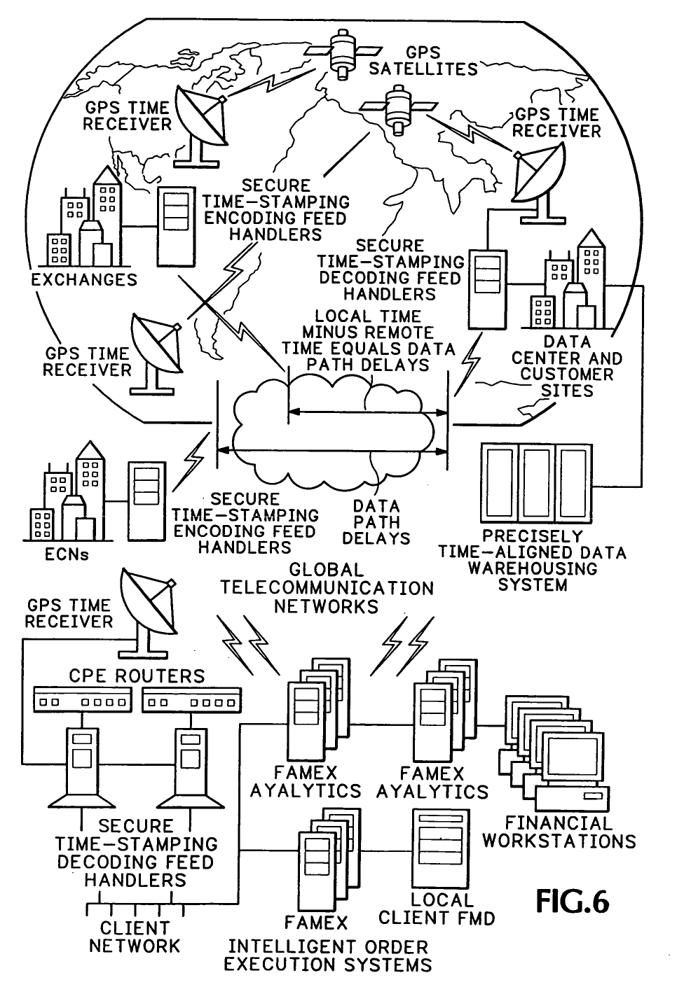

FIG. 6 provides a more detailed depiction of the FIG. 5 system in operation.

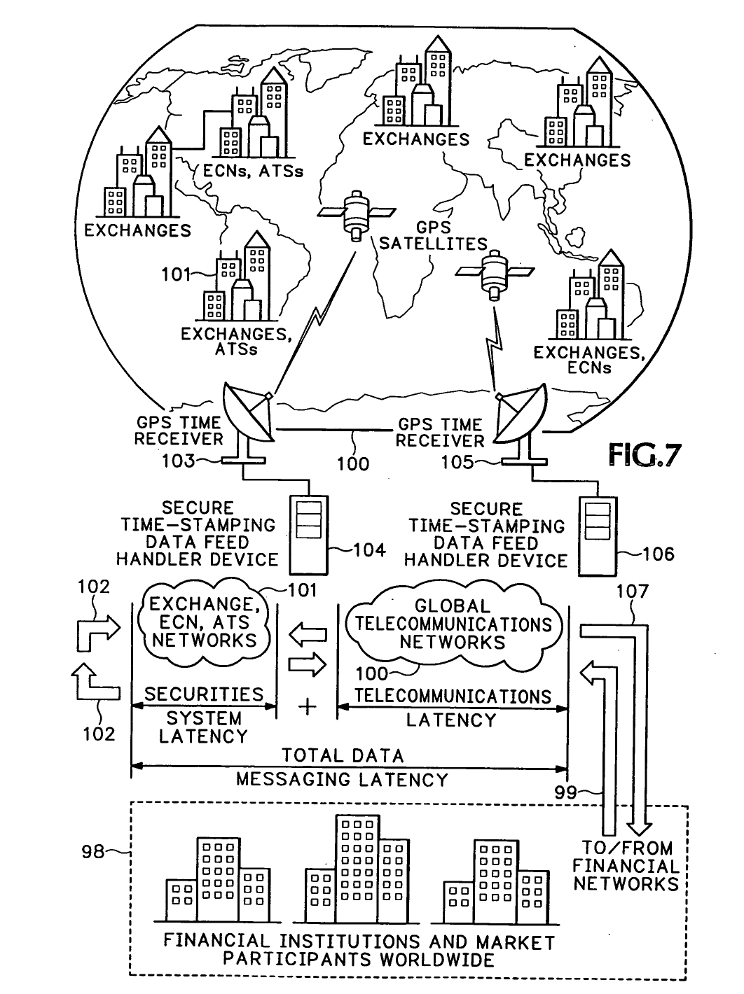

Turning to FIG. 7, each financial institution or other market participant 98 transmits data such as orders, indications of interest, quotes, etc., by placing them first on an internal link, such as link 99, which is connected to a global telecommunications network 100, such as the Internet. Encoder 106, which time stamps data received from networks 100 as described above, can also be used to time stamp data applied to the network via link 99. As described above, encoder 106 is synchronized via a GPS receiver 105. In a financial systems context, there are preferably at least two encoders instead of only encoder 106, each encoder stamping data that flows in only one direction.

After data is so stamped and applied to network 100, it is again stamped by encoder 104 upon receipt at one of the securities systems 101, such as an exchange, ECN, ATS, etc. As described above, encoder 104 is synchronized via a GPS receiver 103. However, Encoder 104 may not necessarily be the same device that also stamps data transmitted from the securities system with which it is associated as it is applied to network 100 for transmission to each market participant, which is also described above. As is the case with encoder 106, in a financial systems context, there are preferably at least two encoders instead of only encoder 104, each encoder stamping data that flows in only one direction.

Turning back to FIG. 7, once data, e.g., an order to buy or sell, is transmitted to a particular security system, it is acknowledged, time stamped by the securities system at 102, as described above (e.g., using NTP), and again stamped by encoder 104, also described above, for transmission via network 100 to each subscriber where it is yet again stamped by each respective encoder 106 and delivered to an individual subscriber via their respective links, like link 107.

Other kinds of data generated by securities system 101 is also time stamped by the securities system, time stamped by encoder 104, transmitted via network 100, stamped again by encoder 106, and delivered to an individual subscriber via respective links, like link 107. Data generated by the securities system 101, includes, e.g., trade information.

When data is transmitted from one of market participants 98 via its respective link, like link 99, and time stamped, first by encoder 106, and then by encoder 104, additional latency information may be generated. Specifically, encoder 104 can function like a transponder by acknowledging receipt of each data packet bound for securities system 101. The acknowledgement comprises a message time stamped by encoder 104 and returned via network 100 to encoder 106. Comparing the time stamp made by encoder 106 when the message was transmitted outbound with the time stamp on the acknowledgement of that data informs the subscriber of the network latency for that message. If network 100 is the Internet, the subscriber might choose not to trade when the latency is above a predetermined level. Or if network 100 is a dedicated path within network 100, referred to sometimes as a direct line, the subscriber might chose to place orders with an different securities system if it is determined that there is unacceptable delay of outbound messages, such as orders, in network 100.

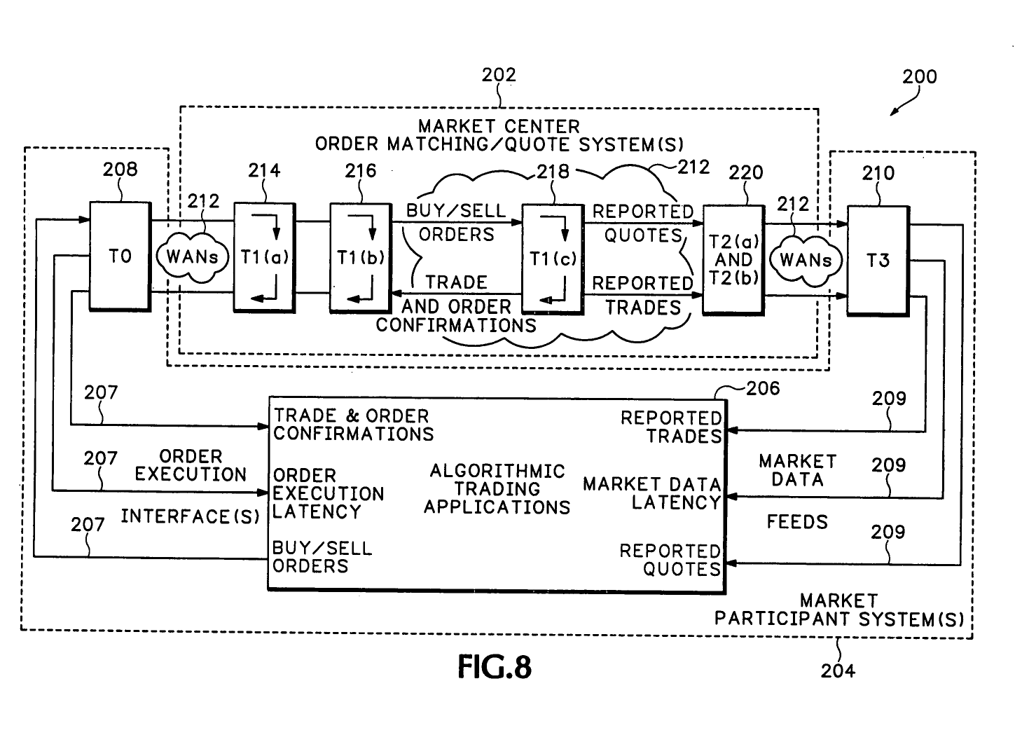

Additionally, all data received, like quotes, by each securities system 101, and all data generated, like trades, by each securities system 101 is time stamped by the securities system at 102, using, e.g., UTC, as described above. A subscriber, such as one of market participants 98, to information provided by one of the securities systems 101 can therefore use data received from a securities system to calculate latency in the security system. This can be done by subtracting the time in the stamp applied by the securities system at 102 from the time stamped by the encoder 104 as the data is transmitted to the subscriber via network 100. This functionality is further illustrated on FIG. 8 via Encoders 208, 216 and 218.

Even though the time stamp applied by the securities system at 102 and the time applied by encoder 104 may not be synchronized in certain embodiments of this invention, important information can be derived-such as the relative accuracy of the time stamp applied by the securities system at 102. For example, if the latency, time at 104 minus time at 102, is negative, one of two things is going on. First, the time standard for applying the stamp at 102 is woefully inaccurate, or, second, there is artificial manipulation of the time stamp applied at 102. Either of these is important for a trader to know.

It can be seen that different latencies injected by communications paths and by the securities system can be accurately calculated by subtracting selected time stamps applied to the data by encoders 104, 106.

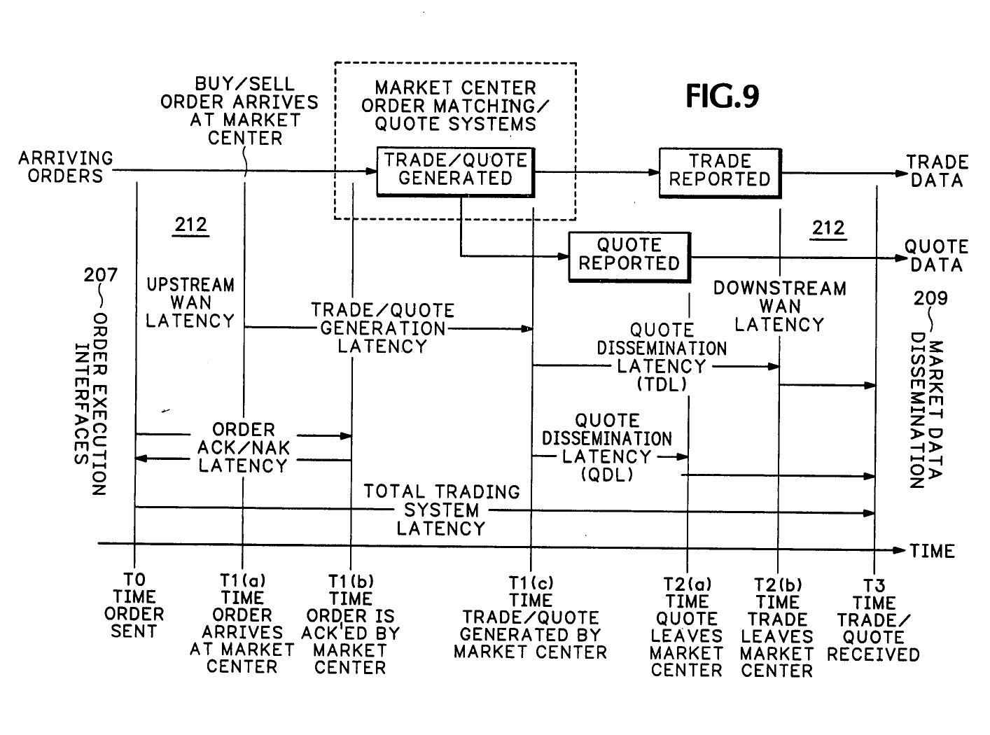

Turning now to FIGS. 8 and 9, consideration will be given to another embodiment of the present invention indicated generally at 200. System 200 includes an exemplary market entity 202, referred to herein simply as a market, that may comprise an exchange, an ECN, an ATS, or the like, as described above. System 200 also includes a market participant 204 that may comprise a stock brokerage or other trader of the financial instruments that are bought and sold in market entity 202. The market participant includes algorithmic trading applications 206 that are typically implemented in computer software. These applications receive inputs from market entity 202 and generate outputs that are provided to market entity 202. The outputs include, among other things, orders to buy or sell financial instruments traded in market entity 202, indicated as Buy/Sell Orders in FIG. 8. These orders may be for buying or selling at the market price or at a specified price and may be otherwise limited in a variety of manners as is well known in the art. Other kinds of outputs (not illustrated in FIG. 8) that algorithmic trading applications 206 may provide to market entity 202, include indications of interest, also known in the art. A buy or sell order has the potential to result in a trade if it is matched with a corresponding sell or buy order in the market. For a trade to occur, a sell order and a buy order must mutually meet the criteria of one another, i.e., they must match.

The inputs to algorithmic trading applications 206 from market entity 202 include, among other things, acknowledgement of receipt of orders and execution of trades, indicated in FIG. 8 as Trade & Order Confirmations. Algorithmic trading applications 206 also receive latency information, including order execution latency and market data latency, indicated in FIG. 8 as Order Execution Latency and Market Data Latency, respectively. These are further described below with reference to FIG. 9. Finally, the algorithmic trading applications 206 also receives reported trades (Reported Trades) and reported quotes (Reported Quotes) from market entity 202, this data comprising quotes generated by a plurality of market participants, including market participants (not shown in the drawings) in addition to participant 206 as well as reported trades and quotes from additional markets (also not shown) beyond market entity 202. The inputs and outputs on the left side of algorithmic trading applications 206 are collectively referred to as order execution interfaces 207. The inputs on the right side of algorithmic trading applications 206 are collectively referred to as market data feeds 209. As is very well appreciated by sophisticated market participants, rapidly disseminated information about the amounts being offered to buy and sell a particular financial instrument in markets throughout the world provides critical information upon which algorithmic trading applications 206 bases decisions to generate and transmit buy or sell orders to various markets.

Market participant 204 includes two encoders 208, 210, designated T0 and T3, respectively. These designations also refer to the times at which data is stamped by encoder 208, 210 and are explained more fully in connection with FIG. 9. Encoders 208, 210 may be constructed and arranged in the same fashion as described in connection with the encoders referred to above. Alternatively, they may be implemented in a single encoder, stamping all data into and out of market entity 202. And any of the encoders herein may even be implemented in software on a computer that may or may not have other functions. In market participant 204, encoder 208 interfaces with communication networks 212 that connect market participant 204, via encoder 208 and networks 212, to market entity 202. WANs 212 may comprise any kind of network, for example an IP based packet network that may comprise the Internet, although for financial transactions like those described here are more commonly private lines provided by a telecommunications company. As used herein the term network can comprise multiple networks that interface with one another or different network paths within a single or multiple networks.

In system 200, encoder 208 handles traffic both to and from market entity 202 that is generated as a result of buy or sell orders sent by algorithmic trading applications 206 to market entity 202. Encoder 210, on the other hand, provides market data, typically from many markets and from many market participants about reported trades and quotes as well as information about the latency of those reported trades and quotes.

Market entity 202 includes encoders 214, 216, 218, 220, which are marked T1(a), T1(b), T1(c), and T2(a) & T2(b). These markings, like those on encoders 208, 210, indicate relative time, which are now discussed with reference to FIG. 9.

In FIG. 9, the designations across the bottom indicate times, such as T0, T1(a), etc., stamped onto a packet of information by the encoder having the corresponding time marked thereon in FIG. 8, like encoders 208, 214, etc. These times as well as message digests are made as described above. First, beginning on the left side of FIG. 9, T0 is the time stamped by encoder 208 onto an order generated by algorithmic trading applications 206 just prior to transmitting the packet representing the order on to a network path in WANs 212.

At time T1(a), the order arrives at encoder 214 in market entity 202 and is stamped with the arrival time. At T1(a), encoder 214 generates a data packet that identifies the order or other data and returns identification along with its time of receipt via a network path on WANs 212 to encoder 208. This in effect generates a confirmation that the order has been received at encoder 214 in market entity 202. This receipt, because it includes the time stamp when received at encoder 214, can be used to calculate, at encoder 208, the time that the order took to move on the network path in WANs 212 from encoder 208 to 214 (and the time for the return trip of the receipt). Algorithmic trading applications 206 is thus informed, via order execution interfaces 207, of the time it took the order to traverse a network path between encoder 208 and 214.

Next, at time T1(b), encoder 216 in market entity 202 generates an order acknowledgement indicating that the order has been received by the automated order matching/quote system implemented at market entity 202. As is the case with encoder 214, encoder 216 generates a data packet associated with the order and the time stamp T1(b) and transmits it via a network path in WANs 212 to encoder 208 and algorithmic trading applications 206. The algorithmic trading applications are, as a result, informed of the order acknowledgement latency, i.e., the length of time between transmitting the order from encoder 208 and acknowledgement of the order by the order matching/quote system in market entity 202. Next, the order matching/quote system tries to match the buy or sell order with a sell or buy order to generate a trade. Two things can happen at this stage.

First, if a match is made, the market system generates a trade, which is then stamped by encoder 218 at time T1(c) with the time at which the trade was generated. As is the case with encoders 214, 216, encoder 218 generates a data packet that is returned to encoder 208 thus informing algorithmic trading applications of the trade generation latency, i.e., how long it took market entity 202 to generate a trade once the order was received at encoder 214 at time T1(a). Again, this information is returned to algorithmic trading applications 206.

Second, if the buy or sell order transmitted from market participant 204 is not matched to create a trade, a quote is generated by market entity 202 and is also stamped by encoder 218 at the time the quote was generated, also designated T1(c) in FIG. 9. This time stamp is also transmitted back to algorithmic trading applications 206, thus providing the quote generation latency.

In addition to informing algorithmic trading applications 206 of the quote or trade generation latency, encoder 218 also reports all the quotes and trades generated by all market participants, not just market participant 204, in market entity 202. Encoder 220 time stamps all such reported quotes and trades just prior to transmitting them on WANs 212 to encoder 210 at market participant 204 and to any other market participant or entity wishing to receive such market data. The information included in these reported quotes and trades includes the time stamp T1(c) applied by encoder 218 and the time stamp T2(a) or T2(b) applied by encoder 220 thus indicating the time between the generation of the quote or trade and the time the quote or trade is disseminated by market entity 202, referred to herein as trade dissemination latency or quote dissemination latency. And because encoder 210 time stamps this received information, the communication latency between encoder 220 via a network path in WANs 212 can be calculated by encoder 210. The communication latency and trade and quote dissemination latency, referred to in algorithm trading applications 206 as market data latency, are then provided to the algorithmic trading applications.

Network 212 is depicted in market entity 202 to symbolize the fact that the encoders and programs that implement the market functions are on a network that may be local, in the case of, e.g., the New York Stock Exchange, or may be distributed and therefore wide area, in the case of, e.g., the National Association of Securities Dealers Automated Quote (NASDAQ) system. These networks that are used to implement a market may be a factor in the latency injected by the market.

As a result of the latency information provided to algorithmic trading applications 206, the automated trade can be made—or not—based on criteria programmed in to applications 206. Such trading decisions may include which market to trade in, which network path to use to and from the market, which path to use to receive market data, what price to set, etc.

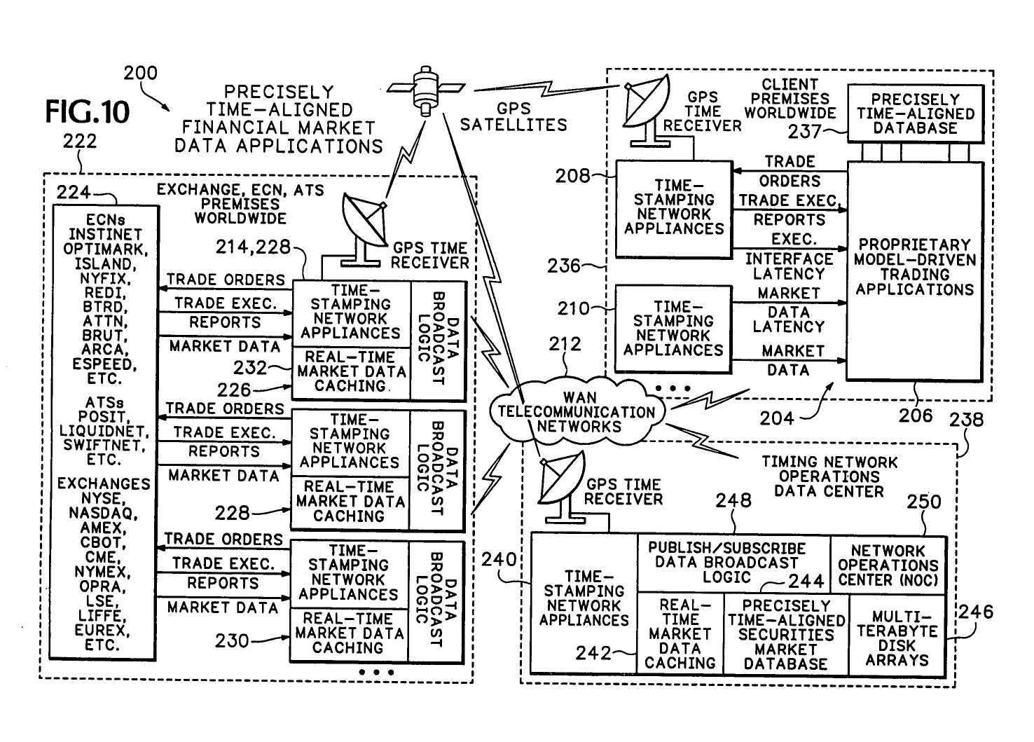

Turning now to FIG. 10, structure corresponding generally to previously described structure is identified by the same numeral. Indicated generally 222 are the markets of interest throughout the world, including market entity 202 from FIG. 8. These market entities 224 may include exchanges, ECNs and ATSs. Each entity 224 includes an interface to the system of the present invention, like interfaces 226, 228, 230. Each interface in the present embodiment of the invention, like interface 226, includes a pair of encoders that stamp information received by each market entity and transmitted from that market entity in the same manner that encoders 214, 220 time stamp information into and out of market entity 202. Each market participant that trades in one of the entities 224 is connected via a network path in WANs 212 to interface 226. As a result, all of the trade orders and other data provided by each market participant to the entity associated with interface 226 are time stamped as they are received from the various market participants. Similarly, trade execution reports like those described in connection with FIG. 8 for all of the market participants in the market entity associated with interface unit 226 are routed through encoder 220, which time stamps them before their return to the market participant that placed the trade. Finally, the third connection between interface 226 and the entity associated with it comprises market data, which is also time stamped by encoder 220 and distributed to whomever would like to receive it, sometimes by a third party service provider as will be explained shortly in more detail.

Interface 226 also includes a real-time market data cache 232. All of the market data is logged as it is stamped and periodically transferred from the cache as will be shortly described.

Finally, the interface unit 226 also includes a data broadcast logic mechanism 234, which distributes the market data in a manner described more fully below.

All of the market participants in market entities 224 are indicated generally at 236. Actually, a single market participant, namely participant 204, is detailed with the ellipses at the bottom indicating similar infrastructure for each market participant in entities 224. Each market participant, like market participant 204, includes a proprietary interface for directly connecting with a particular one of entities 224. As a result, if a market participant, e.g., a stockbroker, trades at a dozen different ones of entities 224, it must connect with a different proprietary interface for each entity. This typically involves providing at least one encoder for each interface. It can therefore be seen that each entity interface, like interface 226, includes a connection from each market participant that trades at that entity. As described above, communication between markets 222 and market participants 236 is via a network path in WANs 212. Each market participant may also include a database 237 for storing all of the order execution data generated by that market participant. As will be more fully described, database 237 may also store all or part of the market data generated by entities 224.

Also included in FIG. 10 is a timing network operations data center 238. Data center 238 is connected to markets 222 and market participants 236 via network paths and WANs 212. The data center includes its own encoder 240 for time stamping data in the same manner as described above. It also includes a market data cache 242, a securities market database 244, which is stored in memory 246. Data center 238 further includes published/subscribed data broadcast logic 248 and network operations center 250.

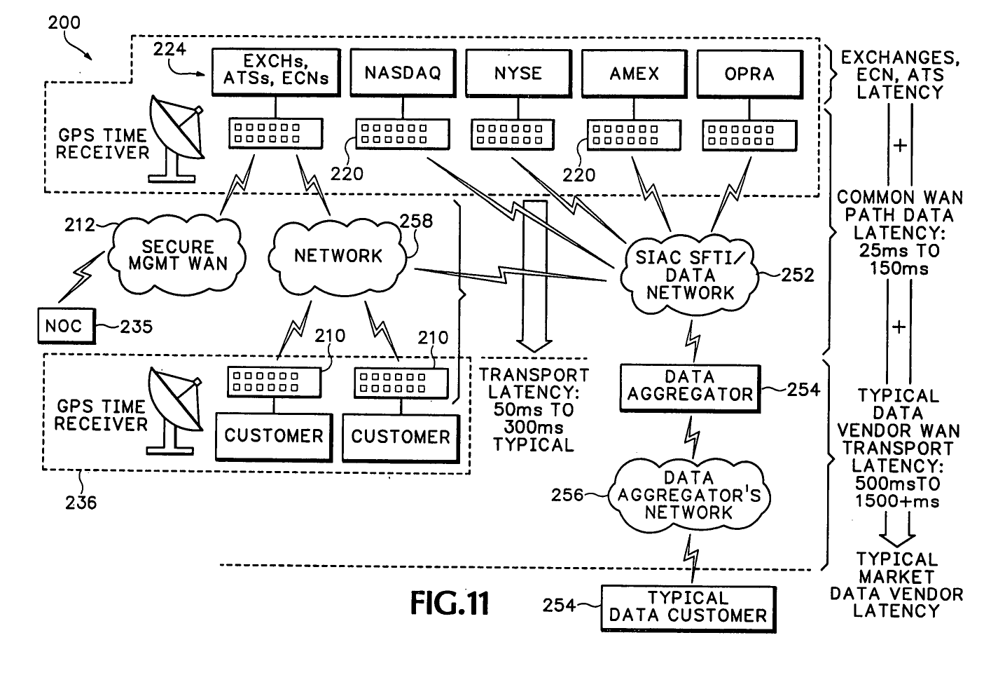

Logic 248 facilitates dissemination of market data from the various market entities 224 to market participants 236 and will be described more fully in connection with the remaining figures. Network operations center 250, among other things, facilitates the functions implemented by encoder 240, cache 242, database 244, memory 246, and logic 248. As will be explained in connection with the description of FIG. 11, center 250 also assures quality of the time stamps implemented by all of the encoders in system 200.

Turning now to FIG. 11, a somewhat different view of the system is shown depicted generally at 200, and includes a data delivery network.

The left-hand side of FIG. 11 depicts an implementation of the present invention similar to that shown in FIG. 10, but-as will be described-also including a data delivery network. The right-hand side of FIG. 11 depicts a prior art approach for providing market data to interested parties. This prior art approach includes a Security Industries Automation Corporation (SIAC) Secured Financial Transaction Infrastructure (SFTI) network 252. Market data including trades and quote information from various markets such as those depicted in FIG. 11 at 224 is applied to network 252. Interested parties can make direct connections via network 252 to any one of market entities 224. From a market participant's perspective, it is expensive to secure dedicated private lines in network 252 that run from the market participant to each of entities 224. As a result, data aggregators, like data aggregator 254, purchase high speed private lines to each of entities 224, collect all the market data coming from each entity, and sell the collected market data to interested parties such as the typical data customer 254. The aggregated data is supplied to customer 254 via a network 256 provided by data aggregator 254. Such data aggregators include companies like Reuters and Bloomberg.

As can be seen by the downward pointed arrow at the far right of FIG. 1, networks 252, processing by data aggregator 254, and network 256 inject latency into market data generated by entities 224. In short, when a customer such as data customer 254 relies upon a data aggregator for market data, that data can be as much as one to two seconds delayed from the time it is generated by entities 224. Based on the current state of algorithmic trading applications, this delay in receiving market data can result in a significant loss of money for a data customer who engages in algorithmic trading based on the market data provided. As a consequence—even though it is quite expensive—many traders who need market data to engage in trading are paying for separate dedicated direct lines in network 252 from each market entity of interest rather than relying on a data aggregator. For some traders, this results in a dozen or more dedicated lines to each market entity of interest.

Considering now how the present invention implements a system for providing market data to customers, a network 258 is used to connect the various entities 224 with market participants or customers 236. In FIG. 11, each of the market entities stamp market data as described in connection with FIGS. 8 and 9 using an encoder 220.

Also like FIG. 8, each market participant has an encoder 210 that time stamps market data as it is received from network 258. To implement communications between market entities 224 and market participants 236 via network 258, a separate Class D IP multicast address is assigned to each market entity from which market data is acquired. In a manner that will shortly be described more fully, each data packet provided by one of the market entities 224 is readdressed or switched by encoder 220 by inserting an IP multicast address corresponding to network 258 into each packet. As a result, subscribing customers 236 each receive the readdressed or switched multicast market data information at the same time along with time stamps from encoders 220 indicating the latency of the information. This data is delivered with at least the equivalent speed of a direct connection to market entities 224 and network 252 but does not require multiple direct connections to market entities 224 and network 252. What is more, customers 236 receive the time stamps, as described in FIGS. 8, 9 and 10 that include information about the network latency and the latency injected by the market entity 224 that provided the data. This data is provided via network 258 over two separate lines that have bandwidth at least equivalent to a T3 line. Because of the critical nature of this financial information, if data from one line should be interrupted as a result of a network failure, the customer system automatically switches to the other line.

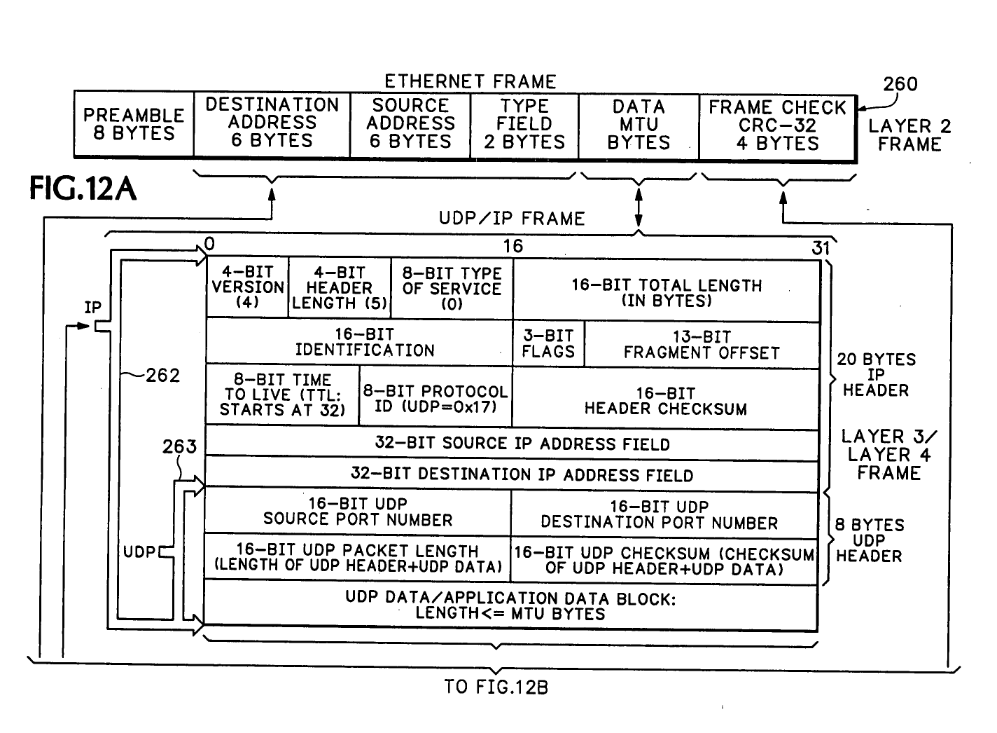

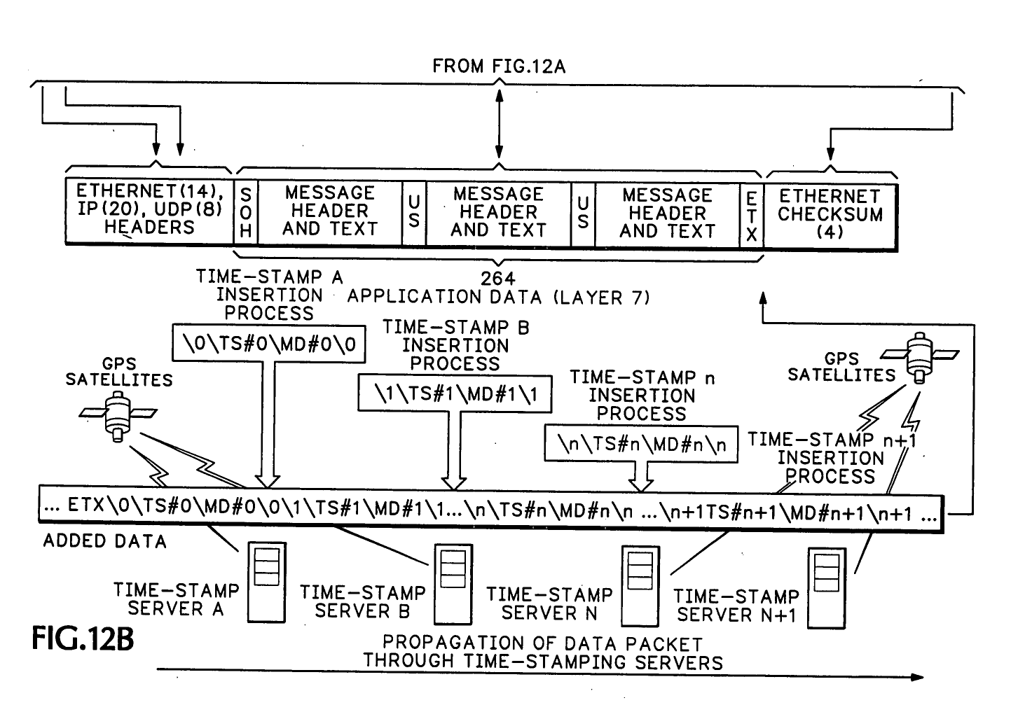

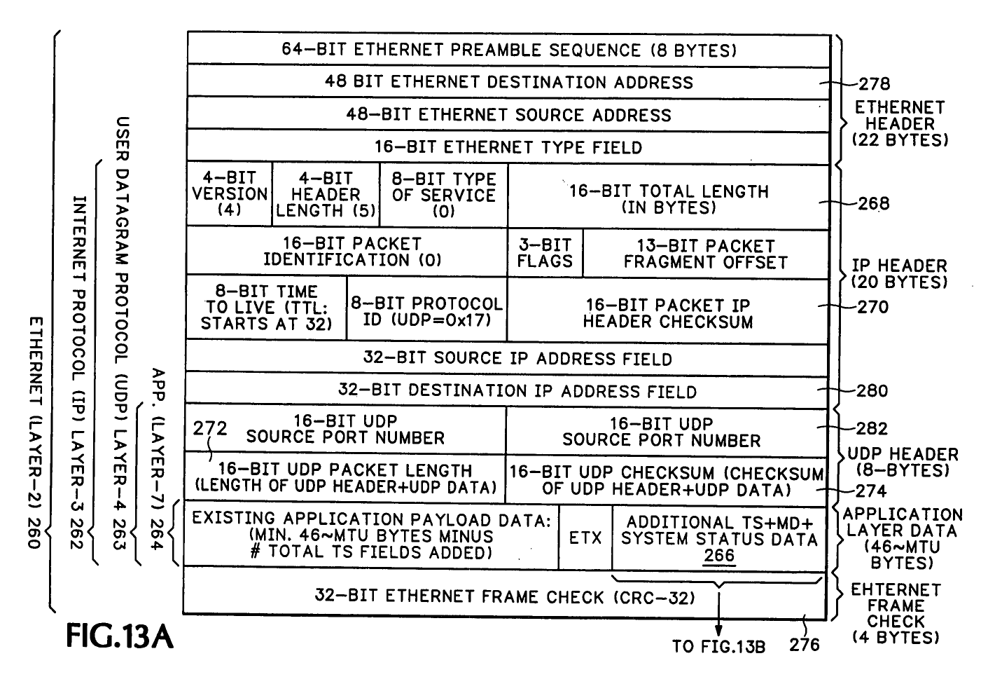

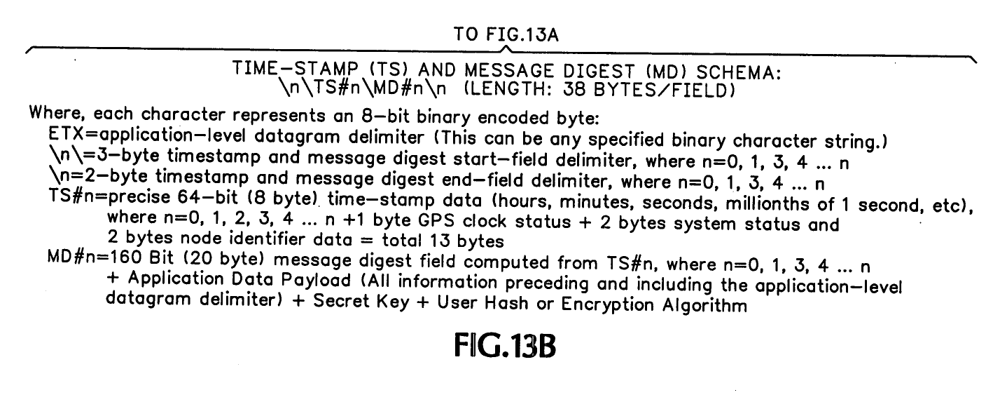

Turning now to FIGS. 12 and 13, more detailed consideration is now given to the format of the time-stamped data packets discussed above and how certain fields in the packet are recalculated, altered, or added. FIG. 12 shows the industry standard formats for an Ethernet frame 260, an IP frame 262, a UDP frame 263, and application data 264. These formats are labeled in accordance with Open Systems Interconnection (OSI) formats for presenting layer 2 (Ethernet frame 260), layer 3 (IP frame 262), layer 4 (UDP frame 263), and layer 7 (application data 264). As is indicated by the brackets and double-ended arrows between various ones of the frames, the Ethernet frame 260 incorporates all of frames 262, 263, and application data 264, as is well known in the art.

As discussed above, time stamp information is inserted in frame 264 after the ETX (end of transmission) field and prior to the Ethernet checksum field. As can be seen in FIG. 12, time stamp and message digest fields are added in sequence as additional time stamps are added. The network maximum transmission unit (MTU) should be large enough to accommodate the additional data that makes up the added time stamp(s). If it is not, downstream packet fragmentation could separate the financial data, or portions of it, from the associated time stamp(s). In the present embodiment, a check is made to confirm that the MTU will not be exceeded if a time stamp is added. If it will be exceeded, the system does not add the stamp.

Turning now to FIG. 13, Ethernet frame 260 is shown in an expanded view including IP layer 262, UDP layer 263, and application data 264. A field 266 includes the added time stamping, GPS clock status, and message digest data, with a more detailed explanation of the format for this added data being depicted at the bottom of FIG. 13.

Various checksums in the various protocol layers in Ethernet frame 260 must be recalculated in view of the data added in field 266. These recalculated fields include fields 268, 270, 272, 274, 276.

In addition to the data added in field 266, other fields must be altered to deliver packet 260 to the appropriate switched address by encoders 220. As described in connection with the implementation in FIG. 11, this end address is an IP multicast address in network 258. These altered fields include fields 278, 280, 282. A person having ordinary skill in this art will readily understand how the fields are to be recalculated, altered or added—and how to implement these changes to deliver frame 260, including the added information, to a desired address without injecting errors.

Because of the many trading rules that define how orders are placed, executed, and acknowledged, time latency information derived as explained above—both within the securities system and within any communications network 100—can be advantageously used by traders to determine how to trade, how to place a trade, and where to trade.

The method described herein can be advantageously applied to any network—not just financial networks—where timing and latency information would be of interest. For example, as mentioned above, timing information for networks associated with the power grid would be useful in determining the nature and cause of power failures. This information consequently is useful in adapting the system to make it more resistant to failure.

Timing or latency information can also be used to optimize performance or to provide new features. For example, stored time-stamped financial information, as described above, can be used to generate algorithms that take advantage of the time-stamped data. These algorithms are created and optimized on historical data. They can then be applied to the time-stamped data that is provided in real time, also as described above. New algorithms will thus be developed that make advantageous use of the time stamping implemented in this method.

The foregoing system permits a user to make a variety of trading decisions based upon the time stamps associated with the data transmitted between markets and market participants as described above. These decisions may include whether to trade at all; the price for an offer to buy or sell; with which market entity, i.e., exchange or the like, to make the trade; what network or network path to use to communicate the offer; and which source of market data to use. Persons having ordinary skill in the art of algorithmic trading applications will appreciate benefits to trading algorithms that may be realized with this additional information. One such example of a trading application that could benefit from latency information like that provided by the present invention is an Order Cancel/Replace (OCR) mechanism. An order could be automatically cancelled, modified, or rerouted based on a predetermined latency threshold or combination of latency thresholds.

In addition to the foregoing, the network is provided for traders to receive market data from a wide variety of markets over a single managed network such as network 258 without delay that is injected by data aggregators with the advantageous time stamps that allow the trader to determine where latency exists and to make trading decisions based on that information.

It should be appreciated that the systems and methods described herein could be used to securely inject or modify autonomously any kind of data—not just timing information—into layer 7 of a network packet, or any lower layer of a network packet if the protocol allows, while producing a properly formed packet that is not rejected by downstream switches, routers or application servers. What is more, such data can be injected into data produced by any distributed computing application or network device on a packetized network, including wireless networks, regardless of the communications protocol used. For example, timing information injected into voice-over IP packets or into data packets to enhance data security can provide improved operation.

In the latter case, the data can be pumped over a packet network using precisely timed receive/transmit intervals. This receive/transmit interval can be encoded into the data along with a time stamp indicating the actual time of receipt or transmission. This encoded interval along with the time stamp acts as a signature that effectively authenticates the data as it propagates through a network from a transmitter to a receiver. Data transmitted or received outside the precisely defined timing interval are simply rejected. Thus, a rogue network device or application cannot simply send rogue data to a packet network device or application. A packet's receive/transmit interval must be properly time-encoded and synchronized, which requires a secret cryptographic key to control this timing process. Packet data that doesn't match the correct receive/transmit timing signature can thus be flagged or rejected as either unauthenticated or erroneous data traffic. Secure military communication and secure financial transactions are examples of potential candidate applications for this invention.

1. A method for optimizing trading using at least one communications network that is connected to a plurality of market participants and to a plurality of markets, said method comprising:
applying a transmit time stamp to a packet of financial data;
applying the packet to the network;
receiving the packet from the network;
applying a receive time stamp to the packet;
computing the difference between the time stamps; and
making a trading decision as a function of the difference.

2. The method of claim 2 wherein a market applies the transmit time stamp and a market participant applies the receive time stamp.

3. The method of claim 1 wherein a market participant applies the transmit time stamp and a market applies the receive time stamp.

4. The method of claim 3 wherein the market processes the data upon receipt of the packet and thereafter applies a second transmit time stamp to a second packet including information relating to the processed data and wherein said method further includes applying the second packet to the network.

5. The method of claim 4 wherein the market participant that applied the first transmit time stamp receives the second packet from the network and wherein said method further includes applying a second receive time stamp.

6. The method of claim 1 wherein the trading decision is selected from the group comprising whether to make a trade, which communications path to use to make the trade, and where to place the trade.

7. The method of claim 1 wherein the transmit time stamp and the receive time stamp are synchronized using a common time source.

8. The method of claim 7 wherein the common time source is a global positioning system.

9. The method of claim 1 wherein the trading system is made substantially in real time.

10. A method of determining latency in connection with executing transactions over at least one communications network, said method comprising:
applying a first time stamp to a packet containing data related to the transaction;
applying the packet to the network;
receiving the packet from the network;
applying a second time stamp to the packet;
processing the transaction;
generating a second packet including data related to the transaction;
applying a third time stamp to the second packet;
applying the second packet to the network;
receiving the second packet from the network; and
applying a fourth time stamp to the second packet.

11. The method of claim 10 wherein said method further comprises computing processing latency by subtracting the second time stamp from the third time stamp.

12. The method of claim 10 wherein said method further comprises computing transmission latency by subtracting the first time stamp from the second time stamp.

13. The method of claim 10 wherein said method further comprises computing transmission latency by subtracting the third time stamp from the fourth time stamp.

14. The method of claim 10 wherein said transaction relates to a market trade and wherein a market participant applies said first time stamp.

15. The method of claim 14 wherein a market applies said second and third time stamps.

16. The method of claim 15 wherein the market participant applies the fourth time stamp.

17. The method of claim 10 wherein said method further comprises making a decision related to execution of transactions as a function of at least two of the time stamps.
